(19) United States
(12) Patent Application Publication
(10) Pub. No.: US 2005/0217495 A1
(43) Pub. Date: Oct. 6, 2005

(54) Thermoplastic food skewers

(76) Inventors: Gordon Smith, Montgomery, OH (US); Robert Taggart, Forth Worth, TX (US); Gregory E. Hindman, Virginia Beach, VA (US); Shanna La'Vonne Moore, Hockessin, DE (US); Peter Albert Tuschak, Wilmington, DE (US); Donna Lynn Visioli, Lower Gwynedd, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/015,952

(22) Filed: Dec. 16, 2004

Related U.S. Application Data
(60) Provisional application No. 60/530,090, filed on Dec. 16, 2003.

(51) Int. Cl. A47J 37/04

(52) U.S. Cl. 99/419

(57) ABSTRACT

Disclosed are thermoplastic food skewers useful for processing foods at high temperatures. Also disclosed are convenience meals that comprise these food skewers. A corndog is a particular example of such a convenience meal.

The present invention claims priority to U.S. Provisional Application No. 60/530,090, filed Dec. 16, 2003, the entire disclosure of which is incorporated herein by reference.

The invention relates to thermoplastic food skewers useful for processing foods at high temperatures and to convenience meals such as corn dogs prepared using these food skewers.

### BACKGROUND OF THE INVENTION

Various foodstuffs such as shish kabobs, fondues, sausages and the like can be placed on skewers and cooked by exposing the foodstuff to heat from ovens, grills, or immersion in hot liquids such as oil, broth, water and the like. In some instances, these foodstuffs are consumed directly from the skewer after cooking. Of note are corn dogs, in which a hot dog is placed on a skewer, dipped in corn meal batter and fried in a hot oil bath. Typically, one eats a corn dog by holding the skewer and biting off portions of the corn dog.

In general, skewers used in cooking food are composed of metal or wood. See, e.g., DE 29712472 and U.S. Pat. Nos. 5,566,997 and 4,258,617.

Metal skewers often have sharp tips, however, and can readily conduct heat. These properties can present safety concerns during their use, since the user is susceptible to accidental injury by puncture or burns. Furthermore, metal skewers are not suitable for use in a microwave oven for reheating the foodstuff. Accordingly, the food typically must be removed from metal skewers for reheating or serving. In addition, metals typically require high temperatures for fabrication into articles by molding techniques and/or their hardness makes machining articles more difficult, resulting in high fabrication costs.

Although wooden skewers do not conduct heat as readily as metal skewers, they can be easily broken, resulting in sharp ends and/or splinters that can injure a user. Such splinters can also be ingested when the food is consumed directly from the skewer. Also, fabrication of wooden skewers requires a number of production steps such as cutting, shaping, sanding and the like that can result in high fabrication costs.

Thus it is desirable to develop new skewers that lower the cost of fabricating skewers or production costs in cooking of foodstuffs. Improved skewer safety is a further desirable goal.

### BRIEF SUMMARY OF THE INVENTION

The invention provides a one-piece food skewer comprising a shaft with at least one blunt end, wherein said skewer consists essentially of, or is produced from, thermoplastic material that does not deform unacceptably when exposed to high temperatures or become unacceptably brittle when exposed to low temperatures. Preferably, the skewer is suitable for use with automated processing machinery.

The invention also provides a convenience meal comprising a foodstuff that is cooked and/or served using the skewer disclosed above.

### DETAILED DESCRIPTION OF THE INVENTION

A convenience meal is a foodstuff wherein at least some of the means for preparing and consuming (i.e. eating) the foodstuff are supplied with the foodstuff. For example, the consumer does not need to supply serving dishes and/or utensils in order to consume the meal.

Hot dogs, also known as frankfurters or wieners, are smoked, seasoned sausages prepared from finely ground meats selected from beef, pork, turkey, chicken or combinations thereof made in long links.

A corn dog is a hot dog that is placed on a skewer, dipped in corn meal batter and fried in a hot oil bath. Typically, the skewer is composed of wood.

Similarly, “breakfast” sausages may be dipped in batter and cooked in hot oil to provide a convenience meal that may be consumed in place of a traditional sausage and pancake meal.

Preparation of foodstuffs, whether manual or using automated processing machinery, requires a skewer that does not substantially deform when exposed to high temperatures (for example, from about 370° F. to about 400° F., or from about 350° F. to about 450° F.) or become unacceptably brittle when exposed to low temperatures (for example, from about −30° F. to about 0° F.). As used herein, “unacceptable deformation at high temperature” refers to a heat distortion temperature or deflection temperature under flexural load that is at or below the cooking temperature of the foodstuff, typically 350° F. to 450° F. The heat distortion temperature is measured under the conditions of ASTM D648 with a load of 66 psi. As used herein, “unacceptable brittleness at low temperature” refers to an Izod impact strength of less than 1 ft-lb/in of notch at the low temperature, typically about 10° F. for storing and shipping a frozen product. The Izod impact strength is measured according to ASTM D256A.

Typically, the skewer is inserted into the foodstuff and used to support the foodstuff throughout the preparation process, which may include such operations as batter-coating, heating, freezing and the like. In addition, optimum mechanical design of the preparation line may require that the foodstuffs placed on skewers undergo several changes in physical orientation as they proceed along the line, often at relatively high speeds and accelerations. It is therefore desirable for the skewer to have sufficient stiffness to resist unacceptable deformation under mechanical stresses, particularly when heated.

Thermoplastic materials suitable for use in preparing skewers of this invention, because of their strength and stiffness at high temperatures, include polyamides or nylons, polybutylene terephthalate and liquid crystal polymers. These materials also do not become unacceptably brittle when exposed to low temperatures.

Preferred are skewers of this invention prepared from poly(hexamethylene adipamide) (PA6,6). Poly(hexamethylene adipamide), which is approved for use in food preparation by the Food and Drug Administration, is available from EI. du Pont de Nemours and Company of Wilmington, Del. (hereinafter “DuPont”) under the tradename Zytel® 101. Other polyamides such as Zytel® HTN, available from DuPont, are also suitable because of their ability to be used in high temperature applications.

Similarly, polybutylene terephthalate, available from DuPont under the tradename Crastin®, and liquid crystal polymers (LCPs), available from DuPont under the tradename Zenite® are other suitable resins for use in the present invention.

The resin may optionally further comprise processing agents such as lubricants to enable efficient molding. Optionally, fillers or reinforcing agents such as carbon black; graphite fibers; glass spheres, fibers, or flakes; silica; titanium dioxide; other pigments; clay; mica; and other mineral fillers or inorganic compounds (e.g. calcium carbonate); fibers; wood flour and the like may be added to increase stiffness and raise softening temperature. Glass fibers are a preferred filler or reinforcing agent.

The skewers comprise a shaft portion having two ends. One end is inserted into the foodstuff so that the shaft is able to support the foodstuff during processing and consumption. Thus, at least one end must be shaped to enable the skewer to be inserted into the foodstuff but not prone to causing injury to a user by, for example, puncture. Blunt ends provide the optimum design to attain these functions. The blunt end may be tapered, rounded, or both tapered and rounded.

The other end of the skewer provides a means for holding the foodstuff in the automated processing machinery to convey the foodstuff through the processing steps. This end is also used as a handle after the foodstuff is processed into a convenience meal. Thus, the ends of the skewer have different functions, and as a consequence the ends may have different shapes. For example, the handle end may have a flattened profile while the end for insertion into the foodstuff is effectively cylindrical with a blunt end. Accordingly, a skewer of this invention comprises a shaft having at least one blunt end.

However, the functions of the two ends are not so different that a common design for the ends suitable for either function may be realized. Thus, a skewer of this invention may be designed so that the ends are identical, so that one end may be inserted into the foodstuff and the other end serve as the handle means without the need for selecting which end serves which function. Accordingly, of note is a skewer of this invention having two blunt ends. Also of note is a skewer that is substantially symmetrical along its longitudinal axis with two blunt ends. As indicated, the skewers of this invention have a shaft for supporting the foodstuff, which may have a cross-sectional profile that is, for example but not by way of limitation, substantially polygonal, e.g., triangular or rectangular; ovoid or circular. When the cross sectional profile comprises three or more vertices, the profile may be rounded at the vertices. Depending on the design, the shape of the cross-section may vary along the length of the shaft. As noted above, the shaft has a blunt end.

A skewer of this invention may optionally further comprise a plurality of reinforcing ribs incorporated into the shaft. The reinforcing ribs may run longitudinally or parallel to the main axis of the shaft, perpendicularly across the main axis of the shaft, at some other angle to the main axis of the shaft, or a plurality of ribs may run in one or more directions with respect to the main axis of the shaft. Of note is a lattice-like network of reinforcing ribs that provide concave voids of triangular, rectangular or rhomboidal shapes in the body of the skewer. When such reinforcing ribs are present, the cross-sectional profile of the shaft will be dependent on the location, number and orientation of the ribs.

The skewers may optionally be provided with elements that provide visual appeal, texture and/or information. Textural elements may be random or regular patterns of convex and/or concave areas on the surface of the skewer. The optional elements may also be provided in the form of graphical images, such as but not limited to alphanumeric text, logos, pictures and the like. These elements may be provided throughout the skewer, or may be limited to a particular area, such as a handle end. These optional elements may be incorporated as embossed or raised above the surface of the skewer, recessed or a combination thereof. They may also be provided by other means, for example, by adhesive attachment, printing and the like. In addition, the skewers of this invention may be prepared in a variety of colors. The skewers may be prepared such that a single color is uniform throughout or may be prepared in a combination of colors that may be random or in a specific pattern.

Preferably, skewers of this invention are fabricated by injection molding. Injection molding can be accomplished using molding procedures, parameters and machines that are well established in the art.

Alternatively, skewers of this invention may be prepared by extrusion of thermoplastic resins through a shaped die to provide a continuous blank of thermoplastic material with a specific cross section that is determined by the shape of the die opening. The blank is cut into pieces of the desired length for a skewer. The cutting of the blank into lengths is typically done in a continuous operation as the blank is extruded out of the die.

Other operations, such as milling, polishing, printing and the like are also contemplated for skewers of this invention.

Of note is a food skewer of this invention comprising a shaft with two blunt ends, said skewer consisting essentially of poly(hexamethylene adipamide) and made in one piece by injection molding.

Also of note is a food skewer of this invention comprising a shaft with two rounded ends, said skewer consisting essentially of poly(hexamethylene adipamide) and made in one piece by injection molding.

As indicated above, this invention also provides a convenience meal comprising a foodstuff that is cooked and served using the same skewer, in which the skewer is made of a heat-resistant thermoplastic material.

In particular, said convenience meal comprises (a) a foodstuff; and (b) a one-piece food skewer comprising a shaft with at least one blunt end, wherein said skewer (1) consists essentially of a thermoplastic material that does not deform unacceptably when exposed to high temperatures or become unacceptably brittle when exposed to low temperatures, and optionally but preferably (2) is suitable for use with automated processing machinery.

The suitable and preferred parameters for the skewer of component (b) of the convenience meal are as set forth above for the food skewer of the invention. Of note is a convenience meal wherein component (b) is a food skewer comprising a shaft with two blunt ends, said skewer consisting essentially of poly(hexamethylene adipamide) and made in one piece by injection molding. Also of note is a convenience meal wherein component (b) is a food skewer comprising a shaft with two rounded ends.

Also of note is a convenience meal wherein the foodstuff of component (a) is a sausage dipped in batter and then cooked in oil, such as a corndog.

The Examples that follow are given for the purpose of illustrating the present invention and are not meant to be limiting. All parts and percentages are by weight unless otherwise specified.

### EXAMPLE 1

Poly(hexamethylene adipamide) resin (available from DuPont as Zytel® 101L), in the form of pellets, was placed into a screw extruder and heated until it became flowable. The melt was injected into a cavity mold with a tab gate to provide a skewer of this invention that is 5.5 inches in length with a rectangular cross-section of 0.25 inches by 0.09 inches. The vertices of the cross-section are rounded. The ends of the skewer have a radius of 0.125 inches. In this example, molded-in embossed alphanumeric text was provided in text boxes 1.3 inches long at both ends of the skewer. Standard injection-molding machines, procedures and parameters were used to prepare Example 1.

### EXAMPLE 2

This example illustrates the preparation of a corn dog convenience meal of this invention using automated processing equipment. The skewer of Example 1 was inserted lengthwise in a hot dog, approximately two ounces by weight, to a depth of about four inches, leaving about 1 to 1.5 inches of the skewer exposed as a handle. A carry bar of an automated preparation line held the handle during the automated processing steps. The hot dog was dipped into a vessel of corn meal batter to be coated with batter. The batter-coated hot dog was immersed in a vessel of hot vegetable oil (from about 380 to about 390° F.) for about 2.5 minutes to cook the coating. After the cooking cycle, the corn dog was rotated (through an angle of 360 degrees) out of the bath over a period of about nine seconds, then rotated again (through an angle of 270 degrees). The corn dog was removed from the carry bar by a stripper device. The corn dog was transported through a freezing station and then packed into boxes for shipment to end-use locations.

Although the invention has been described hereinabove on the basis of preferred and alternate embodiments, it is evident that it is not restricted thereto. On the contrary, alterations and modifications may be made by a skilled person within the framework of the above teachings without thereby departing from the spirit and essence of the invention, as is set forth in the following claims.

1. A one-piece food skewer comprising a shaft with at least one blunt end, wherein said skewer consists essentially of, or is produced from, thermoplastic material that does not deform unacceptably when exposed to high temperatures or become unacceptably brittle when exposed to low temperatures.

2. The skewer of claim 1 wherein the thermoplastic material is suitable for use with automated processing machinery.

3. The skewer of claim 1 wherein said thermoplastic material comprises a material selected from the group consisting of polyamides, polybutylene terephthalate and liquid crystal polymers.

4. The skewer of claim 3 wherein said thermoplastic material comprises poly(hexamethylene adipamide).

5. The skewer of claim 1 prepared by injection molding.

6. The skewer of claim 1 having two blunt ends.

7. The skewer of claim 6 that is substantially symmetrical along its longitudinal axis.

8. The food skewer of claim 1 comprising a shaft with two blunt ends, said skewer consisting essentially of poly(hexamethylene adipamide) and made in one piece by injection molding.

9. The skewer of claim 1 further comprising a plurality of reinforcing ribs incorporated into said shaft.

10. The skewer of claim 1 further comprising a filler or reinforcing agent selected from the group consisting of carbon black; graphite fibers; glass spheres, fibers, or flakes; silica; titanium dioxide; clay; mica; inorganic compounds; fibers; and wood flour.

11. The skewer of claim 10 wherein the filler or reinforcing agent comprises glass fibers.

12. A convenience meal comprising a foodstuff and a skewer, wherein the foodstuff is cooked and served using the same skewer, and in which the skewer is made of a heat-resistant thermoplastic material.

13. The convenience meal of claim 12 wherein the skewer is a one-piece food skewer comprising a shaft with at least one blunt end.

14. The convenience meal of claim 12, wherein said skewer consists essentially of a thermoplastic material that does not deform unacceptably when exposed to high temperatures or become unacceptably brittle when exposed to low temperatures.

15. The convenience meal of claim 12 wherein the skewer is suitable for use with automated processing machinery.

16. The convenience meal of claim 12 wherein said thermoplastic material comprises a material selected from the group consisting of polyamides, polybutylene terephthalate and liquid crystal polymers.

17. The convenience meal of claim 12 wherein said thermoplastic material comprises poly(hexamethylene adipamide).

18. The convenience meal of claim 13 wherein the food skewer comprises two blunt ends, consists essentially of poly(hexamethylene adipamide), and is made in one piece by injection molding.

19. The convenience meal of claim 12, wherein the skewer further comprises a filler or reinforcing agent selected from the group consisting of carbon black; graphite fibers; glass spheres, fibers, or flakes; silica; titanium dioxide; clay; mica; inorganic compounds; fibers; and wood flour.

20. The convenience meal of claim 19, wherein the filler or reinforcing agent comprises glass fibers.

21. The convenience meal of claim 12 wherein the foodstuff is a sausage dipped in batter and then cooked in oil.

22. The convenience meal of claim 21 being a corn dog.
